(19) United States
(12) Patent Application Publication
(10) Pub. No.: US 2012/0113400 A1
(43) Pub. Date: May 10, 2012

(54) EASILY-ASSEMBLED REAR PROJECTION SYSTEM WITH COMPACT STORAGE

(76) Inventor: Fun-Tun Tsen, Taipei City (TW)

(21) Appl. No.: 13/102,008

(22) Filed: May 5, 2011

(30) Foreign Application Priority Data
May 6, 2010 (TW) 099208513

(51) Int. Cl. G03B 21/28

(52) U.S. Cl. 353/99

(57) ABSTRACT

An easily assembled and collapsible rear projection system comprises an easily dismantled and assembled fixture, a projector, a screen and three to five plane mirrors. The fixture is composed of extruded aluminum multi-hole tubes, H-shaped tubes, die-cast aluminum angled bolt holders, extruded aluminum coupling bolt holders, aluminum plates and bolts to join the tubes at various angles for mounting the projector and relative position of the plane mirrors. The multi-hole tubes have five holes passing through the tubes in parallel. There are four holes located at four corners and one at the center of the cross-section of the tube. The coupling bolt holder is used to join the tubes at a 180 degree angle. The angled bolt holder is used to join tubes at various angles. The fixture of the rear projection system is designed for fast dismantling into four modules, including top, a bottom, a front and a back subassemblies, by simply removing the coupling bolt holders.

### CROSS-REFERENCE TO RELATED APPLICATIONS

This application claims the benefit of Taiwanese Patent Application 099208513, filed on May 6, 2010, and incorporated herein by reference.

### STATEMENT REGARDING FEDERALLY SPONSORED RESEARCH AND DEVELOPMENT

Not Applicable.

### FIELD OF THE INVENTION

The present invention discloses an easily-assembled rear projection system which is compactly storable and used for home entertainment and multi-purpose public displays.

### DISCUSSION OF RELATED ART

Front projection technology is frequently used to enlarge and display images for a large crowd of viewers. The image is projected from the viewer side, such as from within a theater; therefore, standing people may block the projection of the image. In addition, front projection does not present a clear image under bright light conditions. On the contrary, rear projection technology resolves the prior mentioned issues in that images are projected on a translucent screen from the opposite side of the viewers. Clearly, rear projection systems are limited from utilizing the space in front of the screen for enlarging the image, as this space is required for viewers to be able to see the screen. Therefore, usually a large space behind the screen is required to achieve a resulting large picture, such as with outdoor displays.

How to shorten the distance between the screen and the projector to achieve a large picture on the screen is one of the biggest challenges with using rear projection technology for large screen TV for indoor entertainment. Prior art devices describe the use of several mirrors aligned in vertical arrangement to reflect the light by mirrors and obtain the required distance of optical path for image enlargement, which effectively condenses the thickness of projection system to be thin enough for indoor accommodation. As screens become larger, the rear projection optical system requires longer distances of the optical path. That is why large screen rear projection systems are usually huge, massive and difficult to transport. As such, creating rear projection systems having small space requirements, yet large screen area, is very challenging.

The image shown at each position of the screen comes from multi-reflection of mirrors. Image distortion occurs when the optical path distances at all positions are not the same. U.S. Pat. No. 7,021,770 stresses the importance of using curved-surface reflecting mirrors to improve the distortion issue by minimizing the differences due to the distances of optical paths. In U.S. Pat. No. 7,239,360, curved-surface reflecting mirrors together with electronic signal calibration are used to solve the image distortion issues. Unfortunately, curved-surface mirrors are difficult to manufacture and expensive. Further, replacement mirrors are usually not exactly the same curvature. Therefore, these challenges make rear projection TV systems expensive to buy and maintain. This prevents rear projection TV from gaining market share.

In U.S. Pat. RE38488, a projector with a short focus range, two plane reflective polarizer mirrors, and a polarizer creates multi-reflection between two plane mirrors to increase the optical path distance. A quarter wave length plate is also used to recycle polarized light in the other direction to prevent the loss of light intensity. Furthermore, the adjustment of the mirrors is extremely important to create the multi-reflection effect. Otherwise, line images coming from the interference of light occur. In addition, quarter wave plate cannot recycle 100% of unused light in all frequencies, which results in color shifted images.

In general, screens are divided into either transparent screens or reflective screens. Transparent screens includes a transparent front layer with a diffusive rear layer. Normally, such screens cannot completely avoid the formation of hot spots and ghost images. In U.S. Pat. No. 7,324,277, a screen is made of a transparent base plate coated with high refraction index particles on both sides. The particles show high optical diffusive characteristics with a refraction index ranging between 2.5 and 3.0. The concentration of the particles in the coating is between 800 and 90,000 ppm, which makes the screen capable of displaying images from both sides without hot spots. The relationship between the coating surface morphology and image quality is not disclosed.

Other than the image distortion issue, the transportation and storage of big screen rear projection TV systems continues to be an issue. The size and weight of big screen systems with huge mirrors creates problems in shipping and land transportation. Big screen TV systems are intended to be used in home entertainment and business applications, e.g. individual or public conferences, marketing application for product promotion, and the like. Therefore, easy assembly, storage and transportation are the keys for meeting the practical needs in versatile applications.

In U.S. Pat. No. 5,796,443, a rear projected TV system with facilitated storage for transportation is described, but the system is relatively large in size once assembled. Therefore, dismantling and relocation are difficult. In U.S. Pat. No. 4,403,815, an easily assembled structure is described. Two plane mirrors with many structural plates and fasteners are used to facilitate dismantling and assembling. The invention is sufficient for relatively small rear projection optical systems. For 50 inches and above, such a screen and structure plates are still too big to transport.

### SUMMARY OF THE INVENTION

In order to design an easily assembled and collapsible rear projection system, plane mirrors with all aluminum hollow trusses and joints are used. There are three to five plane mirrors used with easy adjustment joints for fine tuning of the mirror positions. Trusts are made from extruded aluminum with several holes in the center to reduce weight while maintaining the structure rigidity.

The present invention of an easily assembled and collapsible rear projection system comprises an easily dismantled and assembled fixture, a projector, a screen and three to five plane mirrors. The fixture is composed of extruded aluminum multi-hole tubes, an H-shaped tube, a die-cast aluminum angled bolt holder, an extruded aluminum coupling bolt holder, aluminum plates and bolts to join the tubes at various angles for mounting the projector and relative position of the plane mirrors. The multi-hole tubes have five holes passing through the tubes in parallel. There are four holes located across four corners and one at the center of the tube. The coupling bolt holder is used to join the tubes at a 180 degree angle. The angled bolt holder is used to join tubes at various angles. The fixture of the rear projection system is designed for fast dismantling into four modules, including a top, a bottom, a front and a back subassembly by simply removing the coupling bolt holders.

### DESCRIPTION OF THE DRAWINGS

For a further understanding of the invention, reference will be made to the following detailed description of the invention which is to be read in connection with the accompanying drawing, wherein:

FIG. 1A is a cross sectional view of an example multi-hole tube of the invention;

FIG. 1B is a cross-sectional view of an H-shaped extruded tube of the invention;

FIG. 2 is a cross sectional view of two additional examples of extruded multi-hole tubes;

FIG. 3 is a cross sectional view of an angled bolt holder;

FIG. 4 is a top and side views of a 3-way right angle bolt holder;

FIG. 5 is a cross sectional view of a coupling bolt holder;

FIG. 6 is a side elevation view of an assembled fixture of the invention;

FIG. 7 is a perspective view of a coupling bolt holder and four right-angle bolt holders of the invention, as fastened to several of the multi-hole tubes;

FIG. 8 is a side elevational view of the multi-hole tube;

FIG. 9 is a

### DETAILED DESCRIPTION OF THE PREFERRED EMBODIMENT

Curved-surface reflecting mirrors are considered capable of reducing the difference in optical paths, resulting in less image distortion; unfortunately, they can never provide a perfect image. It is very difficult to tune the distorted image with the adjustment of curved-surface mirrors and signal compensation. Plane mirrors are considered to be the only way of achieving a nearly perfect image; although perfect alignment of such mirrors is critical. A sturdy structure is also required to prevent misalignment caused by shaking or vibration during usage. In the present invention, plane mirrors are used to obtain a nearly perfect image by securing the mirror positions in proper alignment with an easily dismantled and assembled fixture 30.

In the present invention, a liquid crystal display (LCD) or Digital Light Processing (DLP) projector 40 is used, preferably DLP technology with a focus range over 1 meter, preferably between 2 to 6 meters. In order to decrease the size, or footprint, of the projection system, three to six mirrors are needed to lengthen the distance of the optical path for image enlargement within this footprint. The mirror quantity depends on the desired size of final image and the desired size of the overall system. The more mirrors that are used, the more precise assembly is required. Mirrors are aligned vertically to result in a compact system size or footprint. Sturdy fixture design is critical in maintaining the image quality. Light-weight, high-stiffness or rigid structural members and joints or holders 6,7,10 for quick assembly are key to an easily constructed fixture 30, which is essential for multi-purpose applications of rear projection systems.

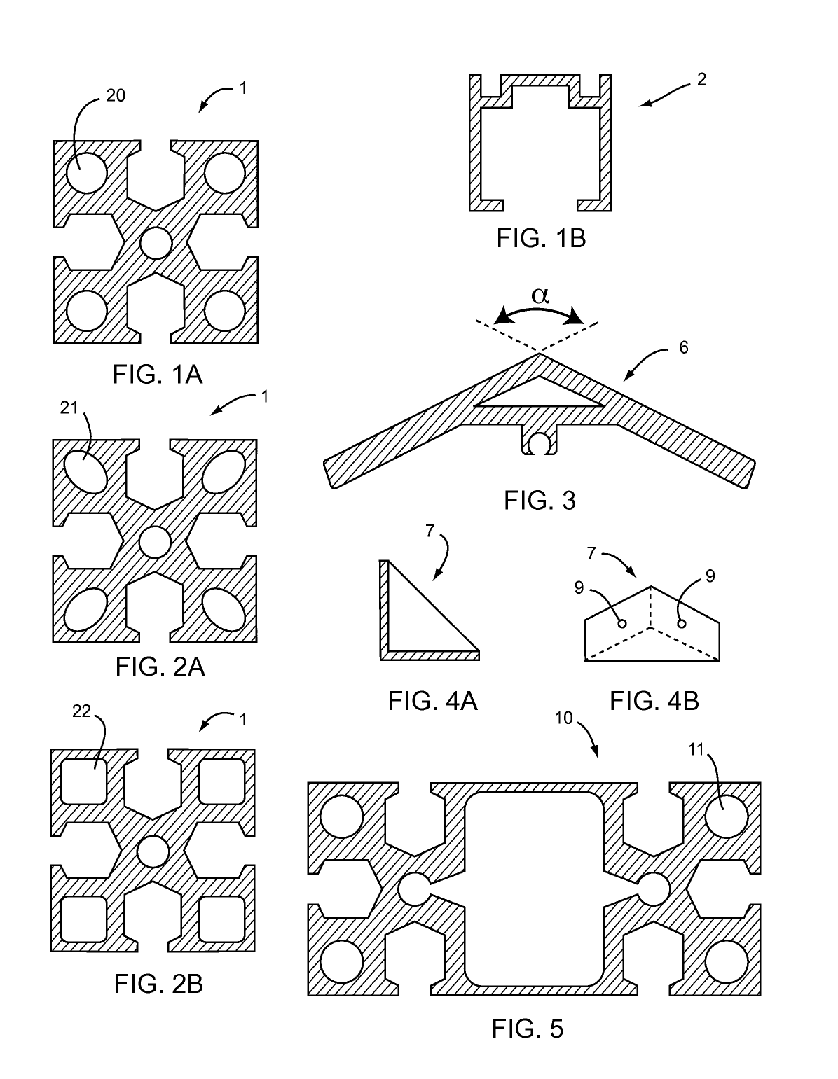

The most important member in the fixture is an extruded multi-hole aluminum tube 1 that provides the required structural stiffness and strength, as shown in FIGS. 1A and 8. Multi-hole tubes 1 and H-shape tubes 2 (FIG. 1B) are joined by bolts 3 (FIGS. 9-11) and several types of quick assembly bolt holders 6,7,10 to couple the tubes 1,2 at different angles α.

The cross section of tubes 1 used herein is usually square and contains five holes 20 therethrough. Four holes 20 are located proximate the four corners and one at the center 20 of the cross section, as shown in FIG. 1A. The shapes of the holes 20 can be circular, oval 21, square 22, rectangular or a combination of the above, as shown in FIGS. 1A, 2A and 2B.

An angled bolt holder 6 joins tubes 1,2 at various angles α, as shown in FIGS. 3, 9-11. Such an angled bolt holder 6 is also a multi-hole structure itself for weight savings. In the construction of a subassembly, angled bolt holders 6 are used at hinged joints to couple elements to achieve designed strength and structural complexity. The angles α are usually 90°, 45° and 135°.

A second bolt holder 7 is a 3-way right angle bolt bracket that joins tubes at 90 degree angles (FIGS. 4A and 4B). The three-way right angle bolt holder 7 may be used to help construct the three dimensional structure. There are holes 9 therein for bolt assembling on each face of the three-way right angle bolt holder 7 (FIG. 10).

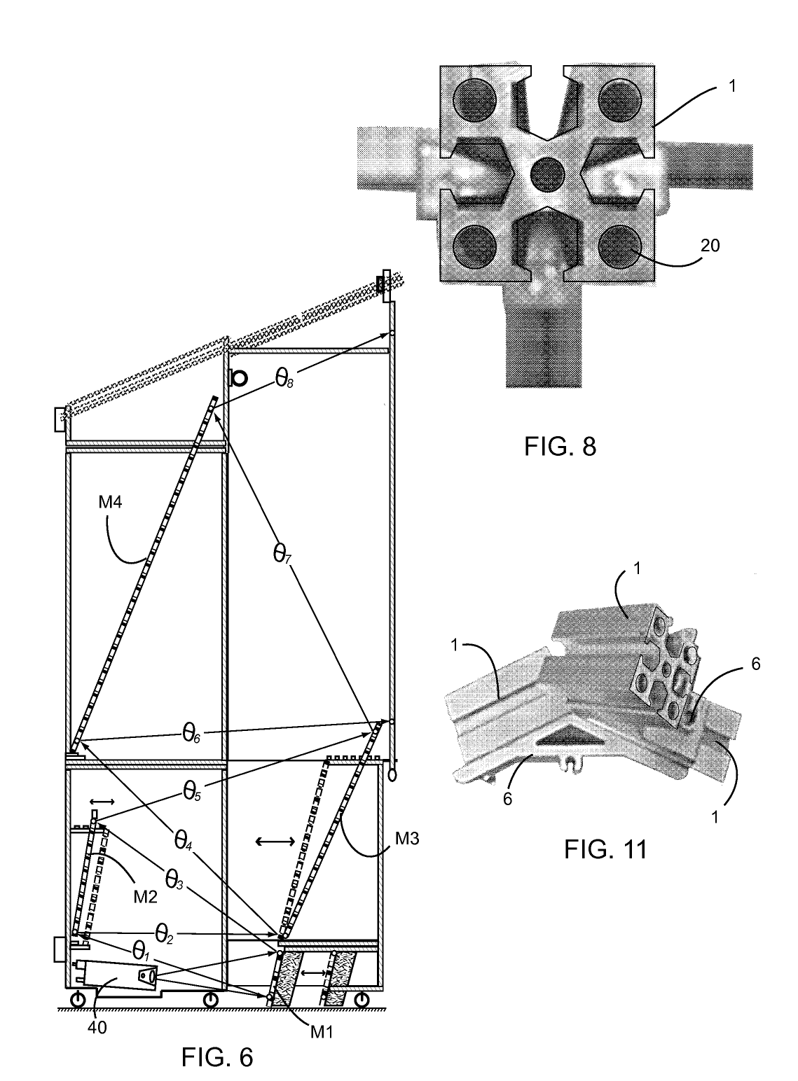

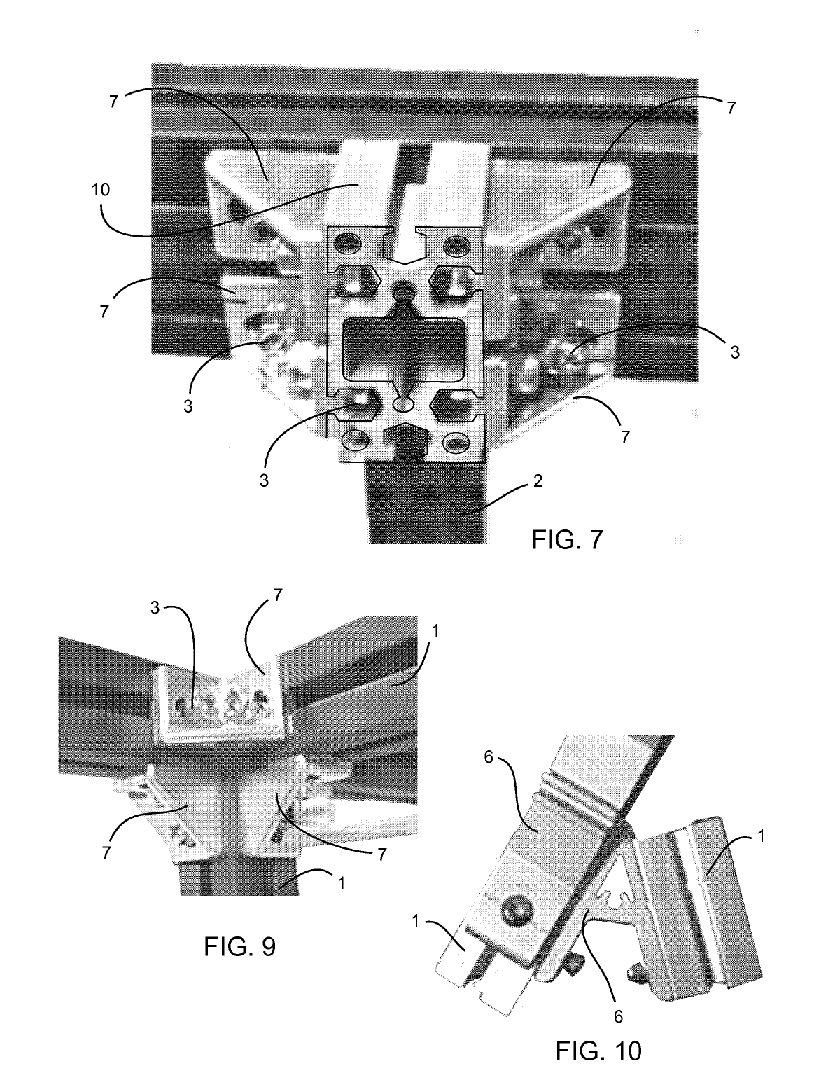

A coupling bolt holder 10 (FIGS. 5 and 7) joins tubes 1,2 at 180 degrees for length extension to form a truss 50 (FIG. 6). In the case of joining subassemblies, the coupling bolt holder 10 is used at a hinged area. The cross section of coupling bolt holder 10 may be described as the integration of two cross sections of multi-hole tubes 1. Four holes 11 are located at the four corners and one at the center of the cross section. The shapes of holes 11 in the coupling bolt holder 10 can be circular, oval, square, rectangular or other shapes.

The present invention is directed towards rear projection systems with a screen size larger than 70 inches, and allows easy transportation and assembly at a relatively low cost. The cost of owning a large screen rear projection TV typically includes the projection system itself, transportation, assembly and maintenance during product life cycle. For fixtures 30 that can be easily taken apart and reassembled, large cost saving benefits may be achieved.

The fixture 30 in the present invention is mainly constructed with the extruded multi-hole aluminum tubes 1 and extruded H-shape tubes 2, as shown in FIGS. 1A and 1B, to achieve proper strength, light weight and low cost. Tubes 1,2 can be joined by bolts 3 and bolt holders 6,7,10 with simple hand tools. Every tube 1,2 is less than 200 cm for easy storage and transportation. The coupling bolt holder 10 is used for joining tubes at 180 degree to extend the effective length of the tubes 1,2, and angled bolt holders 6 are used for constructing tubes 1,2 into a three dimensional structure.

The extruded tubes 1,2 provide the rigidity and stability of the fixture 30 for precision mounting of the projector 40 and mirrors to achieve and maintain the optimal image quality expected from plane mirrors without distortion. All tubes 1,2, bolts 3, bolt holders 6,7,10, cover sheets (not shown) and a venting screen 7 are made of aluminum to prevent galvanized erosion which may impact the strength and integrity of the fixture 30. The weight of the system highly affects the overall cost of the system during the product's life cycle. Therefore, the bolt holders 6,7,10 are mostly hollow structures to reduce the overall weight.

Together with the use of two right angle bolt holders 7, coupling bolt holder 10 can easily join subassemblies into the integrated fixture 30. The shape and dimension of the coupling bolt holder 10 can be made to cooperate with the types of tubes 1,2 to be joined. The holes 11 in the coupling bolt holder also vary with the dimension of the bolt holders 11.

The rear projection system in the present invention can be disassembled into four component groups, such as (i) plane mirrors, (ii) projectors 40, stereo and adjacent electronics, (iii) screen 5 and (iv) fixture 30. The fixture 30 can be further broken down to four components, namely top, bottom, front and back subassemblies (not shown), for easy transportation.

Other than the heat dissipation design of the projector 40, no additional fan or heat sink is needed in general. The heat generated from the system is vented through the aluminum porous screen 7 on top of the fixture 30 by natural convection.

In order to achieve a high resolution image without hot spots, a coated, double-sided, and transparent screen 5 is used to ensure a sufficient light diffusing effect. The light transmission of the screen 5 is preferably 9% to 20% with a haze value above 25. The coating surfaces have half-sphere convex micro structures with average protrusion height Rₐ between 3 and 15 microns. The average distance among protrusions Sₘ is between 20 and 150 microns.

The base material for the screen 5 is a transparent plastic film which is rollable for compact storage without the risk of breakage.

The plane mirrors used in the present invention are back reflecting mirrors. In general, four mirrors are used and divided into two pairs. The two pairs of mirrors are mounted on the front and back of the fixture 30, with an average distance of between 15 cm and 80 cm. The depth of the rear projection system is between 65 cm and 130 cm.

Preferred embodiments of the present invention are described below by way of an example. However, the present invention should be in no way restricted by the example provided.

### Example #1

The example described here is for a 101 inch rear projection system. A Digital Light Processsing (DLP) projector 40 is used with a focus range of between 1.2 and 12 meters. The projector is positioned to stoop, or tilt downwardly, about 11 degree. The first reflective mirror M1 “looks up”—that is, is tilted upwardly—13 degree to guide the light to a second reflective mirror M2 stooping between 9 and 10 degree, followed by a third mirror M3 looking up 23 degrees and a fourth mirror M4 stooping between 20 and 21 degree.

The dimensions of present projection system are 235 cm in height, 230 cm in width and 100 cm in depth. For the purpose of transportation, the system is dismantled into a top portion (139 cm in height, 230 cm in width and 50 cm in depth), and bottom portion (78 cm in height, 230 cm in width and 50 cm in depth). Both portions can be further broken down to front and back subassemblies (not shown). Plane mirrors M1—M4 allow compact packaging and prevent damage from breakage.

In this example, four plane mirrors M1—M4 are used to increase optical length for enlarging the image and reducing the size of the system at the same time. The relative distance between two pairs of mirrors is 15 cm to 80 cm, preferably 30 cm to 60 cm. Calibration of the four mirrors M1-M4 requires very high precision tuning.

The framework of the fixture is designed with trusses and ribs to provide the necessary strength and stiffness. Such trusses and ribs are formed with the multi-hole tubes 1 and the H-shape tubes 2, as shown in FIGS. 1A and 1B, and typically made from extrusion of aluminum. The size of the tube 1 is 3 cm by 3 cm in cross section. Truss and ribs are joined by a plurality of angled bolt holders 6,7 and coupling bolt holders 10 to provide the sturdy three-dimensional framework of the fixture 30. The size of the coupling bolt holder 10 is 3 cm by 6 cm in cross section. Aluminum plates with thickness of 1.2 cm are used to cover the fixture 30 for protecting mirrors M1-M4 and the projector 40. More than 95% of the materials used in the fixture 30 are made of aluminum, which is light weight and recyclable.

The fixture 30 is composed of four modules (not shown) which are top, bottom, front and back. Such modules are connected by coupling bolt holders 10 and right angle bolt holders 7. Each module is less than 160 cm in height for easy transportation with apartment elevator, for example, rather than with a crane.

The screen 5 is coated with diffuser layers on both sides having light transmission of 9% to 30% and a haze level above 20 (not shown). A base film of the screen is a transparent polymeric film which is usually Polyethylene terephthalate (PET) or polycarbonate (PC). The diffuser coating material is based on a UV curable acrylate resin having micro particles. The particles are usually made of silicon dioxide or acrylate of 0.5 to 20 microns in diameter. Followed by UV curing on one side of the film, the coated film is subjected to a second diffuser coating on the other side. The micro structures of the coating surfaces are half sphere convex with a protrusion height Rₐ of between 3 and 15 microns. The average distance among protrusions Sₘ is between 20 and 150 microns.

Although a preferred embodiment has been illustrated and described for the present invention, it will be appreciated by those of ordinary skill in the art that any method or apparatus which is calculated to achieve this same purpose may be substituted for the specific configurations and steps shown. This application is intended to cover any adaptations or variations of the present invention. Therefore, it is manifestly intended that this invention be limited only by the appended claims and the equivalents thereof.

What is claimed is:

1. An easily-assembled and compactly-storable rear projection system, said system comprising:
a projector,
a screen,
three to five plane mirrors, and
an easily-dismantled and assembled fixture comprising a plurality of extruded multi-hole tubes, a plurality of H-shape tubes, a plurality of die-cast angled bolt holders, a plurality of extruded coupling bolt holders, and a plurality of bolts for joining the tubes together at various angles to provide a framework for mounting the projector, screen and the plane mirrors.

2. The easily-assembled and compactly-storable rear projection system according to claim 1 wherein the holes of said multi-hole tubes are located at four corners and a center of said tubes.

3. The easily-assembled and compactly-storable rear projection system according to claim 1 wherein the holes of said multi-hole tubes are selected from the group of shapes comprising: circular, oval, and square.

4. The easily-assembled and compactly-storable rear projection system according to claim 1 wherein said angled bolt holders comprise a triangle hole at a center thereof.

5. The easily-assembled and compactly-storable rear projection system according to claim 1 wherein the angles of said angled bolt holders are selected from the group comprising: 90°, 45° and 135°.

6. The easily-assembled and compactly-storable rear projection system according to claim 1 wherein said coupling bolt holders are multi-hole hollow structures with dimension suitable for joining two of the said multi-hole tubes mutually together.

7. The easily-assembled and compactly-storable rear projection system according to claim 1 wherein more than 95% of said tubes, bolts and bolt holders are made of recyclable aluminum.

8. The easily-assembled and compactly-storable rear projection system according to claim 1 wherein the quantity of said mirrors is exactly four, such mirrors grouped into two pairs each arranged 20 cm to 70 cm apart from each other.

9. The easily-assembled and compactly-storable rear projection system according to claim 1, wherein the fixture can be further broken down into four modules by removing said coupling bolt holders, thereby resulting in top, bottom, front and back subassemblies thereof.

10. The easily-assembled and compactly-storable rear projection system according to claim 1 wherein said screen comprises a half-sphere convex micro-structure on two surfaces of the screen, each micro-structure having an average protrusion height of between 3 and 15 microns and an average distance between protrusions of between 20 and 150 microns.
